(19) United States
(12) Patent Application Publication
(10) Pub. No.: US 2011/0059781 A1
(43) Pub. Date: Mar. 10, 2011

(54) CELLULAR PHONE HOLSTER CASE

(75) Inventor: Ki Sub Sin, Seoul (KR)

(73) Assignee: Newvit Co., Ltd, Seoul (KR)

(21) Appl. No.: 12/688,169

(22) Filed: Jan. 15, 2010

(30) Foreign Application Priority Data
Sep. 9, 2009 (KR) 10-2009-0085095

(51) Int. Cl. H04W 88/02

(52) U.S. Cl. 455/575.6

(57) ABSTRACT

Disclosed is a cellular phone holster case having a belt clip part. The holster case includes a rear plate having one side closely contacting a cellular phone and the other side engaged to the belt clip part, and a front plate connected to the rear plate at a lower end thereof to form a receiving space. The front plate is provided with a notch for dividing the front plate into two parts, and a support member is installed in the rear plate and the front plate.

### CROSS-REFERENCE TO RELATED APPLICATION

This application is based on and claims priority from Korean Patent Application No. 10-2009-85095, filed on Sep. 9, 2009 in the Korean Intellectual Property Office, the disclosure of which is incorporated herein in its entirety by reference.

### BACKGROUND OF THE INVENTION

1. Field of the invention

The present invention relates to a cellular phone holster case, and more particularly, to a cellular phone holster case having a belt clip and a retaining space for retaining a cellular phone therein, in which the cellular phone holster case is carried at a user's waist to maintain stability of the cellular phone, without interfering with activity of the user.

2. Description of the Prior Art

With the development of information communication technology, cellular phones have been essential goods of life for modern persons. Recently, the cellular phone is provided with various functions of DMB, camera and/or MP3, in addition to a function of calling or answering the telephone simply. Thus, the cellular phone is recognized as one of new advanced equipments, or some of persons frequently replace a normal cellular phone with a new one as a portion of accessories, in spite of an expensive product.

At present, most of users carry the cellular phones with their hands, hang the cellular phones on their necks or wrists, or put the cellular phones in their bags or handbags, or pockets of clothes.

In the case of carrying the cellular phone with the hand, however, the cellular phone is likely to be lost or damaged when missing, and it causes the user inconvenience while carrying it with the user's hand.

In the case of hanging the cellular phone on user's neck or wrist, it frequently collides with something, and similar to the case of carrying it with the hand, it causes the user inconvenience. In the case of keeping the cellular phone in the bag or the like, the user is hard to feel vibration of the cellular phone which is a vibration mode. Further, in the case in which the user takes care of his or her business while the bag is spaced apart from the user, the user does not quickly come to the cellular phone for urgent call.

In order to solve the above problems, a cellular phone holster case has been proposed to prevent the cellular phone from being lost or damaged by the applied impact, to enable the user to easily deal with vibration or calling sound, and to be useful for the activities, by fixing the cellular phone to a belt by using a clip structure.

In particular, slim cellular phones and color cellular phones become main items in the market of cellular phone in Korea recently. Meanwhile, since leather holster cases for a cellular phone which are generally worn at waists of middle-aged men are transformed in a conspicuous way, youngsters entertain goodwill for the holster cases, and thus the sales volume of the cellular phone holster cases is dramatically increased recently. Consequently, the cellular phone holster case is settled down as a necessary article.

In the case of a cellular phone holster case which is fixed to a belt and keeps the cellular phone therein, although it prevents missing and secures the activities and stability. However, since the holster case is designed to have a thickness slightly thicker than the cellular phone, the cellular phone is fitted in the inside of the holster case to some extent. When the cellular phone is put out from the holster case, it is difficult to extract it from the holster case with the user's fingers. Occasionally, if the holster case is detached from the belt and the holster case is turned upside down, the cellular phone can be easily extracted from the holster case. When the cellular phone is again put in the holster case, it is often inconvenient to directly put the cellular phone in the holster case. In the course of putting the cellular phone in the holster case, the cellular phone is possibly dropped.

Moreover, in consideration of aesthetic, shock absorption, and stability of the holster case, it is generally made of somewhat hard leather. In this instance, the external shape of the holster case is not stationary, so that it is hard to put the cellular phone in or out the holster case. As strong deformation force is applied to the holster case or the use time is prolonged, the shape of the holster case is deformed, so that it is difficult to use it.

### SUMMARY OF THE INVENTION

Accordingly, the present invention has been made to solve the above-mentioned problems occurring in the prior art while advantages achieved by the prior art are maintained intact.

One object of the present invention is to provide a cellular phone holster case which can enable a user to easily extract a cellular phone from a case body with a user's hand, and can maintain a shape of the case body constantly irrespective of a material of the case body.

In order to accomplish these objects, there is provided a cellular phone holster case having a belt clip part, the holster case including a rear plate having one side closely contacting a cellular phone and the other side engaged to the belt clip part; and a front plate connected to the rear plate at a lower end thereof to form a receiving space, wherein the front plate is provided with a notch for dividing the front plate into two parts, and a support member is installed in the rear plate and the front plate.

(1) According to an embodiment of the present invention, the front plate is provided with the notch to divide the front plate into two parts to form a gap, so that a user's finger is inserted into the gap to push the cellular phone up. Therefore, gripping and extracting of the cellular phone and extracting can be performed by one action, and thus a user can deal with sudden calling or urgent calling. When the cellular phone is put in, the user can put the cellular phone in the holster case by holding it with his or her finger through the space of the notch, thereby preventing the cellular phone from being dropped.

(2) A cellular phone holster case of a related art has the activities and stability, in addition to the prevention of the missing. However, since the holster case is designed to have a thickness slightly thicker than the cellular phone, the cellular phone is fitted in the inside of the holster case to some extent. When the cellular phone is put out from the holster case, it is difficult to extract it from the holster case with the user's fingers. As a result, in the case of again putting the cellular phone in the holster case after use, the insertion is difficult. According to an embodiment of the present invention, the holster case includes the support member installed in the rear plate and the front plate and made of a material having hardness and resiliency of a predetermined level, and the support member is extended from an upper end of the rear plate and is bent to have a predetermined curvature at a bottom thereof to hole the cellular phone. When the cellular phone is again put in the holster case, the cellular phone can be easily inserted in the holster case by slightly pushing an upper end of the cellular phone.

Moreover, with the support member inserted in the rear plate and the front plate of the cellular phone holster case according to the present invention which forms a receiving space and determines a shape of the holster case, (3) it is possible to prevent excessive deformation from occurring when the cellular phone holster case is made by using only a soft material, such as leather, and (4) the front plate and the rear plate are connected to each other by the support member, without performing a process of coupling separate front and rear plates in the cellular phone holster case of a related art, thereby easily forming the receiving space.

(5) When the cellular phone holster case is made, the cellular phone holster case can be maintained in a constant shape, without using a hard material in consideration of the stability. Consequently, the cellular phone holster case is excellent in aesthetic point of view, and the surface thereof can be machined to have various designs.

Finally, (6) since the support member has not only hardness also resiliency of a predetermined level, the user can conveniently put the cellular phone in or out from the cellular phone holster case, while the entire shape thereof is maintained.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a cellular phone holster case according to an embodiment of the present invention;

FIG. 2 is a right cross-sectional view of the cellular phone holster case in FIG. 1;

FIG. 3 is a view illustrating a use state of the cellular phone holster case in FIG.. 1;

FIG. 4 is a perspective view of a cellular phone holster case according to another embodiment of the present invention;

FIG. 5 is a right cross-sectional view of the cellular phone holster case in FIG. 4;

FIG. 6 is a view illustrating a use state of the cellular phone holster case in FIG. 4;

FIG. 7 is a view illustrating a state in which a belt clip part is fixed and a state in which the belt clip part is rotated at an angle of 90 degrees;

FIG. 8 is a view illustrating an article receiving structure for the cellular phone holster case shown in FIGS. 1 to 3; and

FIG. 9 is a view illustrating an article receiving structure for the cellular phone holster case shown in FIGS. 4 to 6.

### DETAILED DESCRIPTION OF THE PREFERRED EMBODIMENTS

Hereinafter, a preferred embodiment of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

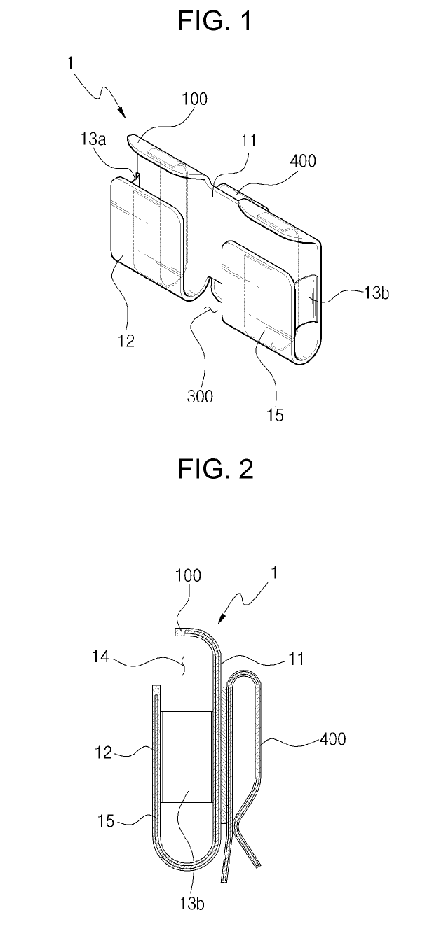

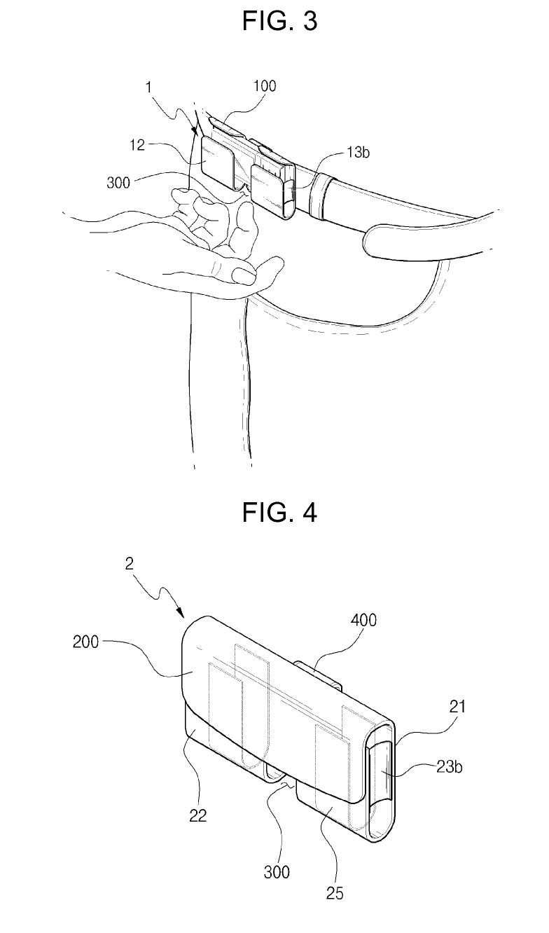

FIG. 1 is a perspective view of a cellular phone holster case 1 according to an embodiment of the present invention. FIG. 2 is a right cross-sectional view of the cellular phone holster case 1 in FIG. 1. FIG. 3 is a view illustrating a use state of the cellular phone holster case 1 in FIG. 1.

Referring to FIGS. 1 and 2, the cellular phone holster case 1 according to the embodiment of the present invention includes a U-shaped support member 15 inserted in a rear plate 11 and a front plate 12 to maintain shapes of the plates, and a holding part 100 integrally formed with the rear plate 11 and the front plate 12 to form a receiving space and hold the cellular phone so as not to slip out through an opening 14.

Further, a left side plate 13a and a right side plate 13b are connected between the rear plate 11 and the front plate 12 so as to prevent the cellular phone from slipping out in a lateral direction and prevent the cellular phone holster case 1 from being excessively deformed. The front plate 12 is connected to the rear plate 12 at a bottom thereof to form a receiving space therebetween, and is provided with a notch 300 for dividing the front plate 12 into two parts so that the cellular phone is easily put out from the cellular phone holster case 1 by holding the cellular phone with fingers from the exterior.

In the cellular phone holster case 1 according to the embodiment, the notch 300 is extended to an upper end of the front plate 12. When the cellular phone is put out, the user pushes up the cellular phone by the fingers inserted through the notch 300, without visually confirming the cellular phone. In this instance, a gap is formed between the cellular phone and the cellular phone holster case 1 when the cellular phone is slightly lifted, and then the user grips the cellular phone with a hand, so that the cellular phone can be extracted from the opening 14 at once. Consequently, the user can deal with sudden calling or urgent calling, and when the cellular phone is put in, the user can put the cellular phone in the holster case by holding it with his or her finger through the space of the notch 300, thereby preventing the cellular phone from being dropped.

A size of the notch 300 is determined so as to enable the user to easily extract or keep the cellular phone in or from the cellular phone holster case 1. That is, the notch 300 has a size slightly larger than a thickness of a thumb of an adult man in consideration of a function of the front plate 12 which pushes a front side of the cellular phone and keeping it safe.

The rear plate 10, the front plate 12, and the right and left side plates 13a and 13b constituting the cellular phone holster case 1 are made of a material having proper thickness and rigidity, such as leather or synthetic resin, enough to receive the cellular phone.

The U-shaped support member 15 is inserted in the rear plate 11 and the front plate 12, and is extended from the upper end of the rear plate 11 to the upper end of the front plate 12, so that a space for receiving the cellular phone is formed between the rear plate 12 and the front plate 12.

The support member 15 has a width smaller than a width of the divided front plate 12 having a function of preventing the deformation and maintaining the shape.

The support member 15 can be formed by using a steel sheet or plastic sheet. Preferably, the support member is made of a material having rigidity enough to prevent breakdown of the support member and slight resiliency.

The support member 15 prevents the shape form being deformed as the material of the cellular phone holster case 1 becomes weak with the passage of time. As a result, the function of the cellular phone holster case 1 is continuously maintained, and in the case in which the cellular phone holster case 1 is worn at a belt with carrying the cellular phone therein, it is possible to prevent the belt from dropping under the weight of the cellular phone holster case 1.

The cellular phone holster case 1 includes a structure for holding the cellular phone so as to prevent the cellular phone from slipping out from the inside. As shown in the embodiment shown in FIGS. 1 to 3, the holding part 100 is extended upwardly from the upper end of the rear plate 11 to the front plate 11 in a bent shape. The support member 15 is installed in the extended portion to cover the opening 14, thereby holding the cellular phone in the cellular phone holster case 1.

Since the holding part 100 has the support member 15, as described above, the cellular phone can be stably kept therein, without using a special structure, such as a cover, for closing the opening 14.

In the case in which the cellular phone is again put in the cellular phone holster case 1 including the holding part 100, since the support member 15 has the slight resiliency and the material of a cover enclosing the support member is soft and resilient, the holding part 100 is slightly pushed toward the rear plate 11, and then the cellular phone is easily inserted along a curved surface of the holding portion 100. However, in the case the cellular phone is put in the cellular phone holster case 1, the cellular phone is tightly fitted therein by the resiliency. In the course of inserting the cellular phone, the user can put the cellular phone in the holster case by holding it with his or her finger through the space of the notch 300, thereby preventing the cellular phone from being dropped.

When the cellular phone is put out to use, the holding part 100 can be easily opened from the opening 14 by using the resiliency of the support member 15. More specifically, after the cellular phone is pushed up towards the opening 14 by the finger inserted in the notch 100, as described above, the cellular phone is extracted along the curved surface of the holding portion 100. It is possible to easily extract the cellular phone at once action, without dropping it.

The cellular phone holster case 1 according to the embodiment includes a belt clip part 400 for stably fixing the cellular phone holster case 1 at a desired position of the belt. As shown in FIGS. 1 to 3, the belt clip part 400 is positioned at a rear side of the rear plate 11.

The belt clip part 400 is attached to the rear side. of the rear plate 11 opposite to the notch 300, and is made of a material having hardness and resiliency so as to fix the cellular phone holster case 1 to the belt and prevent the belt from dropping under the weight of the cellular phone. The belt clip part 400 is adapted to rotate by a predetermined angle with respect to the cellular phone holster case 1.

Since the belt clip part 400 is rotated and fixed as described above, the cellular phone can be put in or out from the cellular phone holster case 1 by moving it in a front or rear direction while the cellular phone holster case 1 is fixed to the belt.

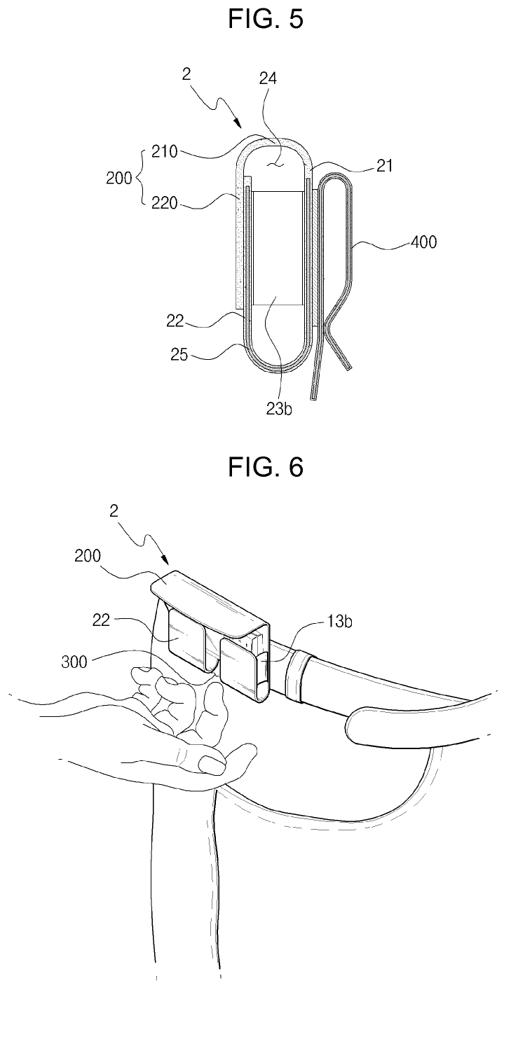

FIG. 4 is a perspective view of a cellular phone holster case 2 according to another embodiment of the present invention. FIG. 5 is a right cross-sectional view of the cellular phone holster case 2 in FIG. 4. FIG. 6 is a view illustrating a use state of the cellular phone holster case 2 in FIG. 4.

Referring to FIGS. 4 to 6, the cellular phone holster case 2 according to the embodiment of the present invention includes a U-shaped support member 25 inserted in a rear plate 21 and a front plate 22 extended from an upper end the rear plate 21 to an upper end of the front plate 22, similar to the cellular phone holster case 1 shown in FIG. 1. The rear plate 21 and the front plate 22 are integrally connected to each other to form a receiving space. Further, a left side plate 23a and a right side plate 23b are connected between the rear plate 21 and the front plate 22 so as to prevent the cellular phone from slipping out in a lateral direction.

The cellular phone holster case 2 includes a structure for holding the cellular phone so as to prevent the cellular phone from slipping out through the opening 24. As shown in the embodiment shown in FIGS. 4 to 6, a covering part 200 has an arc connecting portion 210 connected to the upper end of the rear plate 21, and a cover 220 extended upwardly from the connecting portion to cover the front plate.

Further, similar to FIG. 1, the front plate 22 is provided with a notch 300 for dividing the front plate 22 into two parts so that the cellular phone is easily put out from the cellular phone holster case 2 by holding the cellular phone with fingers from the exterior.

With the cellular phone holster case 2 according to the embodiment, the notch 300 is formed in the front plate 22. When the cellular phone is put out, the user pushes up the cellular phone by the fingers inserted through the notch 300. In this instance, a gap is formed between the cellular phone and the cellular phone holster case 2 when the cellular phone is slightly lifted, and then the user grips the cellular phone with a hand, so that the cellular phone can be easily extracted from the opening 24. Further, when the cellular phone is put in, the user can hold the cellular phone with his or her finger through the notch 300. Consequently, it is possible to put in or out the cellular phone, without dropping the cellular phone.

Since the cellular phone holster case 2 includes the cover part 200, it is possible to prevent the cellular phone from slipping out from the inside by the left side plate 23a and the right side plate 23b.

In the case in which the cellular phone is again put in the cellular phone holster case 2 including the holding part 200, the cellular phone is easily inserted to the connecting portion 210 from the opening 24, and in the course of inserting the cellular phone, the user can put the cellular phone in the holster case by holding it with his or her finger through the space of the notch 300, thereby preventing the cellular phone from being dropped.

According to a method of attaching the cover 220 of the cellular phone holster case 2 to the front plate 22, the support member 25 inserted in the front plate is made of a magnet, and the cover 220 has a material having a function of maintaining the shape constantly and a magnetic property, so that the cover 220 can be easily attached to the front plate 22 by using a magnetic force, without special manipulation. Alternatively, the cover 220 and the front plate 22 are provided with a Velcro or a snap button at a contacting portion.

Further, similar to the embodiment shown in FIG. 1, the portion enclosing the cellular phone holster case 2 is made of a material having proper thickness and rigidity, such as leather or synthetic resin, enough to receive the cellular phone. The U-shaped support member 25 is inserted in the rear plate 21 and the front plate 22, and is extended from the upper end of the rear plate 21 to the upper end of the front plate 22, so that a space for receiving the cellular phone is formed between the rear plate 22 and the front plate 22.

Preferably, the support member 25 is made of a material having hardness and resilience of a predetermined level, such as a steel sheet or plastic of polymer compound. The support member 25 prevents the shape. form being deformed as the material of the cellular phone holster case 2 becomes weak with the passage of time. As a result, the function of the cellular phone holster case 2 is continuously maintained, and in the case in which the cellular phone holster case 2 is worn at a belt with carrying the cellular phone therein, it is possible to prevent the belt from dropping under the weight of the cellular phone holster case 2.

According to this embodiment, similar to the embodiment shown in FIGS. 1 to 3, the cellular phone holster case 2 includes a belt clip part 400 for stably fixing the cellular phone holster case 2 at a desired position of the belt.

The belt clip part 400 is attached to the rear side of the rear plate 21 opposite to the notch 300, and is made of a material having hardness and resiliency so as to fix the cellular phone holster case 2 to the belt. Preferably, the belt clip part 400 has an angle adjusting portion which is rotated with respect to the cellular phone holster case 2.

In these embodiments of the present invention, the belt clip part 400 is adapted to rotate in a clockwise direction or counterclockwise direction by an angle of 90 degrees.

Since the belt clip part 400 is rotated and fixed as described above, the cellular phone can be put in or out from the cellular phone holster case 2 by moving it in a front or rear direction while the cellular phone holster case 1 is fixed to the belt.

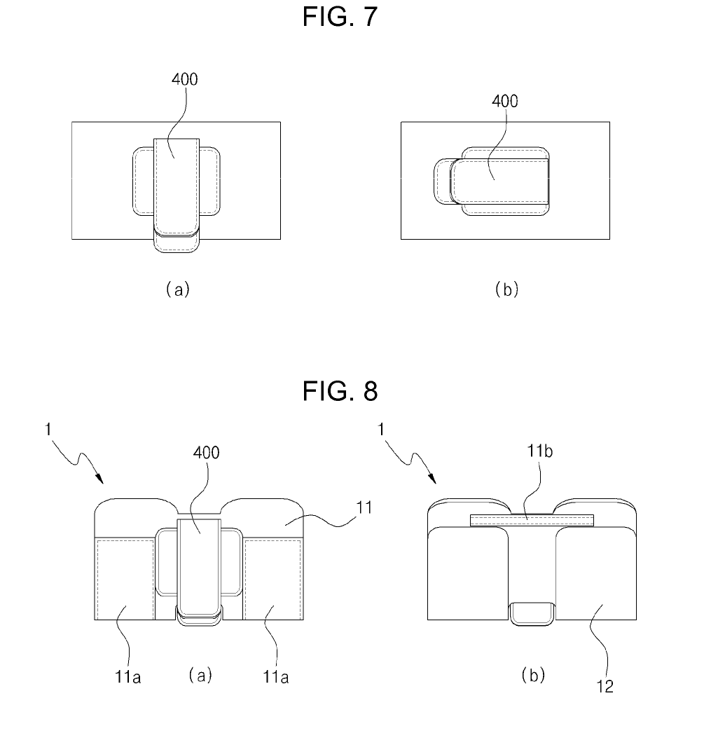

FIG. 7A is a view illustrating a state in which the belt clip part 400 is fixed, and FIG. 7B is a view illustrating a state in which the belt clip part 400 is rotated at an angle of 90 degrees.

FIG. 8A is a view illustrating an example in which the rear plate 11 of the cellular phone holster case 1 shown in FIGS. 1 to 3 is provided with a pocket 11a for receiving an article, such as gender or USB memory, adjacent to the belt clip part 400, and FIG. 8B is a view illustrating an example in which the front side of the rear plate 11 is provided with a holder 11b for receiving, for example, a stylus pen.

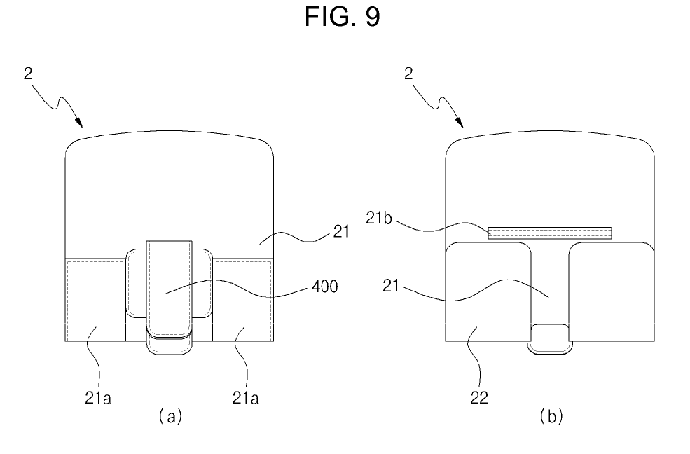

Similar to the example shown in FIG. 8, FIG. 9A is a view illustrating an example in which the rear plate 21 of the cellular phone holster case 2 shown in FIGS. 4 to 6 is provided with a pocket 21a for receiving an article, such as gender or USB memory, adjacent to the belt clip part 400, and FIG. 9B is a view illustrating an example in which the front side of the rear plate 21 is provided with a holder 21b for receiving, for example, a stylus pen.

In the case of cellular phones recently manufactured, a charger for charging a battery is fabricated to have the same standard, but the battery can be generally charged by using different gender depending upon kinds of the cellular phones.

Therefore, the charger can be commonly used even though only the gender is carried, thereby conveniently charging the cellular phone.

Moreover, cellular phones applied with new technology, such as a touch pad, are generalized, and as the use of advanced equipments, such as DMB, is increased, the efficiency of the stylus pen is further increased. Further, all data related to businesses is processed by a computer, and the use of USBs is remarkably increased in order to store or utilize the data.

In the case of the above-described products, since they are too small, it is difficult to keep them in a pocket or a bag, and they are easily damaged or lost. A space for separately receiving the product is necessary since it is an important article.

In order to solve the above problem, the cellular phones according to the embodiment shown in FIG. 1 and the embodiment shown FIG. 2 include the belt clip part 400 having the pocket formed at either of both sides to receive a product therein, and the holder for fixing the stylus pen, as shown in FIGS. 8 and 9.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A cellular phone holster case having a belt clip part, the holster case comprising:
a rear plate having one side closely contacting a cellular phone and the other side engaged to the belt clip part; and
a front plate connected to the rear plate at a lower end thereof to form a receiving space,
wherein the front plate is provided with a notch for dividing the front plate into two parts, and a support member is installed in the rear plate and the front plate.

2. The cellular phone holster case as claimed in claim 1, wherein the belt clip part is rotatably connected to the rear plate.

3. The cellular phone holster case as claimed in claim 1, further comprising a holding part extended from an upper end of the rear plate in a curved shape, and the support member is installed in the holding part.

4. The cellular phone holster case as claimed in claim 1, further comprising a cover part having a connecting portion connected to an upper end of the rear plate, and a cover extended from the connecting portion to cover the front plate.

5. The cellular phone holster case as claimed in claim 4, wherein a magnetic force acts between the cover and the support member.

6. The cellular phone holster case as claimed in claim 1, wherein the rear plate is provided with a receiving portion formed adjacent to the belt clip part.
